(19) United States
(12) Patent Application Publication
(10) Pub. No.: US 2011/0087978 A1
(43) Pub. Date: Apr. 14, 2011

(54) Usage Based Process For Selecting Hardware And Software In A Build To Order Environment

(76) Inventors: Sabrina Sellers, Gatesville, TX (US); Trisha Collier, Round Rock, TX (US)

(21) Appl. No.: 12/576,369

(22) Filed: Oct. 9, 2009

(51) Int. Cl. G06F 15/177; G06F 3/048

(52) U.S. Cl. 715/764; 713/1

(57) ABSTRACT

A usage based process for selecting hardware and software in a build to order environment. During the configuration of an information handling system, the usage based process presents a survey to a customer and uses information derived from the survey to automatically populate an information handling system configuration. In certain embodiments, the process of auto-populating the information handling system configuration includes a configuration accuracy analysis to assure that the various components identified for the auto-population provide a completed and accurately configured information handling system.

### BACKGROUND OF THE INVENTION

1. Field of the Invention

The present invention relates to information handling systems and more particularly to a usage based process for selecting hardware and software in a build to order environment.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

There is not a method today that gathers the user's interest and needs along with system requirements to perform and meet the user's relevant task(s). Example, users are not aware of what Hardware and Software to purchase to perform their task. User wants to edit and create dvds but is unaware of Hardware that would allow them to create DVDs without decreasing their system performance.

### SUMMARY OF THE INVENTION

In accordance with the present invention, a usage based process for selecting hardware and software in a build to order environment is set forth. More specifically, during the configuration of an information handling system, the usage based process presents a survey to a customer and uses information derived from the survey to automatically populate an information handling system configuration. In certain embodiments, the process of auto-populating the information handling system configuration includes a configuration accuracy analysis to assure that the various components identified for the auto-population provide a completed and accurately configured information handling system.

In certain embodiments, the survey includes a plurality of questions that are presented to a customer via a questionnaire. Additionally, in certain embodiments, the plurality of questions include questions regarding a user environment of system (e.g., a home environment, an office environment, a student environment or a professional environment), questions regarding potential usage of system (e.g., photo editing, listening to music, video editing, gaming, and digital entertainment), questions regarding types of applications to be used or documents that will be manipulated by the system (e.g., certain types of productivity applications, financial applications), questions regarding the ecosystem in which the system will reside (e.g., technology ownership, electronic devices, home networks) and questions regarding whether the system will be coupled to a network and if so the type of network (e.g., Wired; Wireless, Online habits: Video Entertainment, Online Services).

Based upon the results of the survey, the configuration system configures a system accordingly. Also in various embodiments, the questionnaire can either be provided prior to a user configuring a system order or after the fact. If the questionnaire is presented after configuring a system, the questionnaire can be used to verify that the configured system meets the needs of the user and if changes need to be made to their current configuration, the usage based process can provide information regarding the recommended changes.

In certain embodiments, access to the usage based process may be provided via a link that is presented during the configuration process. Alternately, in certain embodiments, access to the usage based process may be provided via a pop up window that is presented during the configuration process or via a tab that is presented within the configuration page. The information presented via the link, pop up or tab may include an indication such as “Help me Order” as well “Verify system Configuration meets needs”.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview of a block diagram representation of an on-line store.

FIG. 2 shows an example of an automated build to order system for installing fixed image software on an information handling system.

FIG. 3 shows a block diagram of an online configuration work flow.

FIG. 4 shows a block diagram of an information handling system configured via the usage based process for selecting hardware and software in a build to order environment.

### DETAILED DESCRIPTION

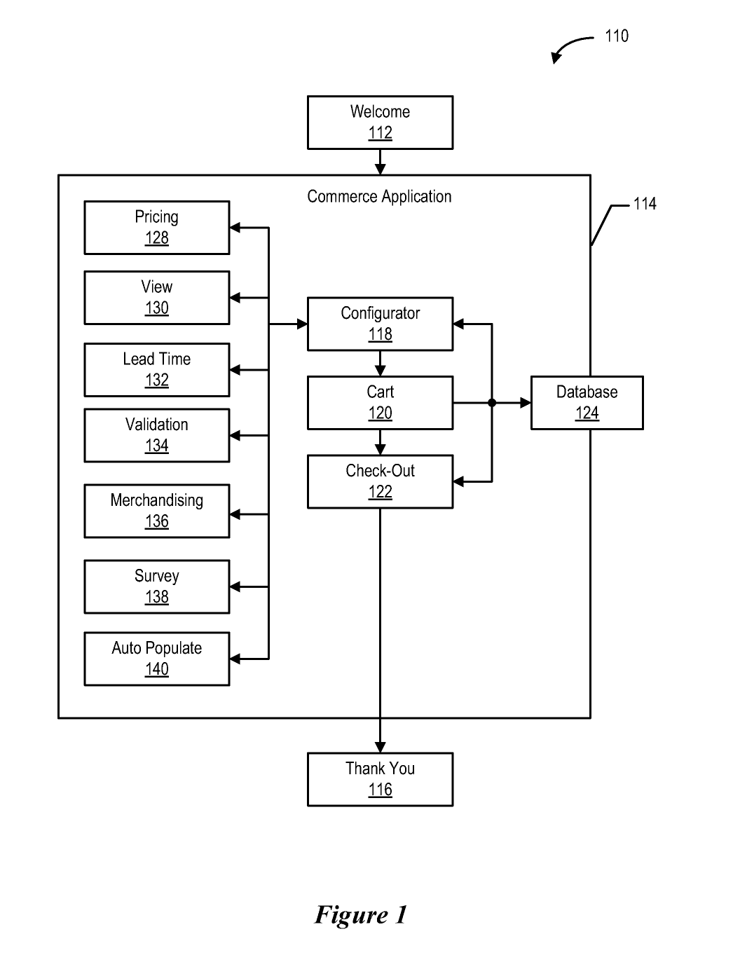

Referring to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface that enables the system configuration, pricing, and ordering of an information handling system via the Internet. The commerce application 114 includes a configurator 118, shopping cart 120, a checkout module 122, and database 124. The database 124 provides information to the configurator 118, shopping cart 120, and a checkout module 122. The configurator 118 includes a pricing module 128, a view module 130, a lead-time warning module 132, a validation (or compatibility) warning module 134, a merchandising module 136 as well as a survey module 138 and an auto populate module 140. The various modules of the configurator 118 are driven by data from the database 124, and thus the configurator 118, shopping cart 120, and checkout module 122 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, and the thank you module 116 presents a thank you page. The welcome page includes a static page and generally resides outside of the commerce application 114. Additionally, if accessed during the configuration, the survey module 138 presents a survey page. The configurator page, shopping cart page, checkout page and survey page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, a customer is transferred to an integrated television configuration page in which the customer is provided an opportunity to provide information that can be used to preconfigure an integrated television on the system. After completion of the configuration, the customer is transferred to a checkout page. After completion of the checkout, the customer is transferred to a static thank you page 116. The thank you page 116 provides a message of gratitude to the customer for having placed the order or for visiting the on-line store.

Aspects of the configurator 118 that interact with database 124 are shown in FIG. 1. In essence, the entire commerce application 114 interacts with the database. The configurator 118, shopping cart 120, checkout module 122, and integrated television configuration module 123 are each part of the commerce application 114 and interact with the database 124. For example, with the shopping cart 120, additional merchandising information associated with a particular system that has been configured and placed in the shopping cart by an on-line store customer can be provided.

By providing the survey module 138, the on-line store provides a usage based process for selecting hardware and software in a build to order environment. During the configuration of an information handling system, survey module 138 the usage based process presents a survey to a customer. The survey module 138 thus queries the customer to collect data for an analysis of an optimal information handling system for the customer. Additionally, by providing the automatic population module 140, the on-line store uses information derived from the survey to automatically populate an information handling system configuration. Additionally, in certain embodiments, the automatic population module 140 includes a configuration accuracy analysis (e.g., by access the validation module 134) to assure that the various components identified for the auto-population provide a complete and accurately configured information handling system.

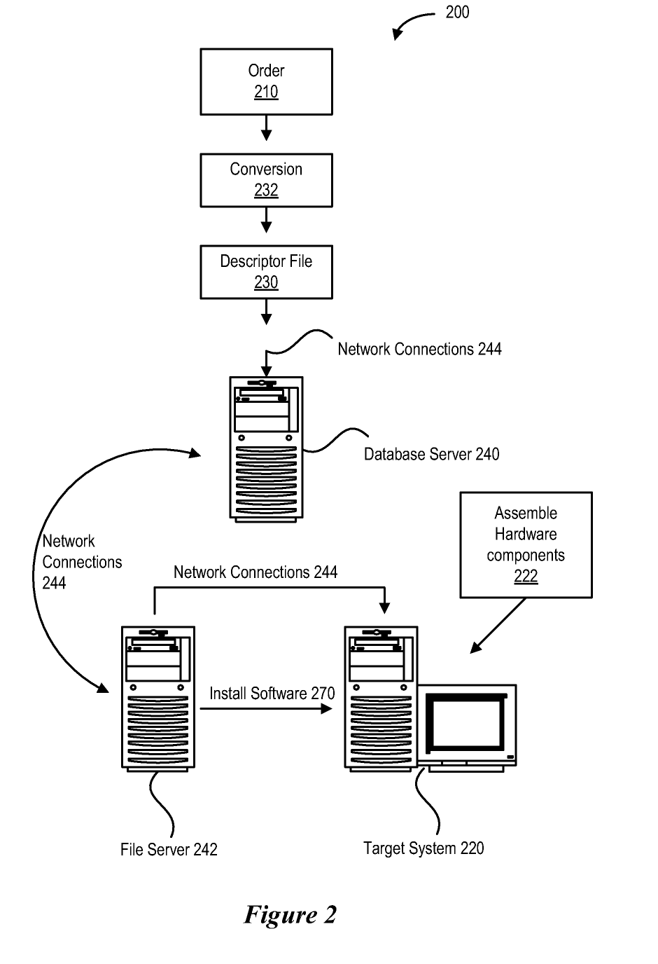

Referring to FIG. 2, a schematic diagram of an installation system 200 at an information handling system-manufacturing site is shown. In operation, an order 210 is placed to purchase a target information handling system 220. The order may be placed via a conventional configuration or via a usage based and facilitated configuration.

The target information handling system 220 to be manufactured contains a plurality of hardware and software components. For instance, target information handling system 220 might include a certain brand of hard drive, a particular type of monitor, a certain brand of processor, and software. The software includes a particular version of an operating system along with all appropriate driver software and other application software along with appropriate software bug fixes. The hardware components of the target information handling system 220 are assembled to provide the target information handling system 220 via a fabrication process 222.

Before target information handling system 220 is shipped to the customer, the plurality of components are installed and tested from, for example, an image of the software. Such software installation and testing advantageously ensures a reliable, working information handling system which is ready to operate when received by a customer.

Because different families of information handling systems and different individual computer components require different software installation, it is necessary to determine which software to install on a target information handling system 220. A descriptor file 230 is provided by converting an order 210, which corresponds to a desired information handling system having desired components, into a computer readable format via conversion module 232. The descriptor file 230 can also include which content to load on the system.

Component descriptors are computer readable descriptions of the components of target information handling system 220 which components are defined by the order 210. In a preferred embodiment, the component descriptors are included in a descriptor file called a system descriptor record which is a computer readable file containing a listing of the components, both hardware and software, to be installed onto target information handling system 220. Having read the plurality of component descriptors, database server 240 provides a plurality of software components corresponding to the component descriptors to file server 242 over network connection 244. Network connections 244 may be any network connection well known in the art, such as a local area network, an intranet, or the internet. The information contained in database server 240 is often updated such that the database contains a new factory build environment. These updates can include new content to install onto the fixed image platform. The software is then installed 270 on the target information handling system 220. The software installation is controlled by a software installation management server that is operable to control the installation of the operating system and other software packages specified by a customer.

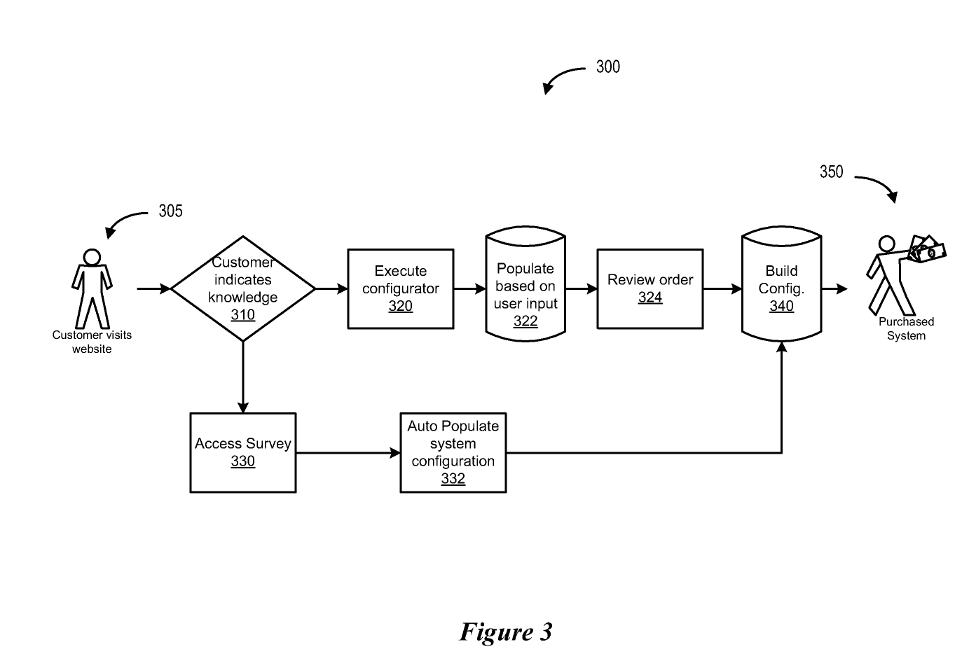

Referring to FIG. 3, a block diagram of a work flow of a usage based process for selecting hardware and software in a build to order environment 300 is shown. More specifically, the process starts when a customer visits the website (e.g., the on-line store 100) at step 305. When the customer accesses the website, the customer provides some form of indication that the customer has knowledge of a type of system they want to order at step 310. If the customer indicates a desire to configure a system themselves then the process proceeds with presenting the configurator at step 320. The configurator then populates a system based upon the customer input at step 322. The configurator then reviews the order for accuracy and completeness at step 324.

If the customer provides an indication of a desire for help in configuring a system at step 310, the usage based process provides access to a survey to a customer at step 330 (e.g., via the survey module 138). The process uses information derived from the survey to automatically populate an information handling system configuration at step 332 (e.g., via the automatic population module 140). In certain embodiments, the process of auto-populating the information handling system configuration includes a configuration accuracy analysis to assure that the various components identified for the auto-population provide a completed and accurately configured information handling system.

After the system is configured, either via the usage based process or via a manual configuration process, then work flow proceeds to build an information handling system corresponding to the configuration at step 340 (where the system may be fabricated via the installation system 200). After which the purchased system is provided to the customer at step 350.

In certain embodiments, the survey may present a plurality of questions that are presented to a customer e.g., via a questionnaire. Additionally, in certain embodiments, the plurality of questions include questions regarding a user environment of system (e.g., a home environment, an office environment, a student environment or a professional environment), questions regarding potential usage of system (e.g., photo editing, listening to music, video editing, gaming, and digital entertainment), questions regarding types of applications to be used or documents that will be manipulated by the system (e.g., certain types of productivity applications, financial applications), questions regarding the ecosystem in which the system will reside (e.g., technology ownership, electronic devices, home networks) and questions regarding whether the system will be coupled to a network and if so the type of network (e.g., Wired; Wireless, Online habits: Video Entertainment, Online Services).

Based upon the results of the survey, the configuration system configures a system accordingly. Also in various embodiments, the questionnaire can either be provided prior to a user configuring a system order or after the fact. If the questionnaire is presented after configuring a system, the questionnaire can be used to verify that the configured system meets the needs of the user and if changes need to be made to their current configuration, the usage based process can provide information regarding the recommended changes. In certain embodiments, access to the usage based process may be provided via a link that is presented during the configuration process.

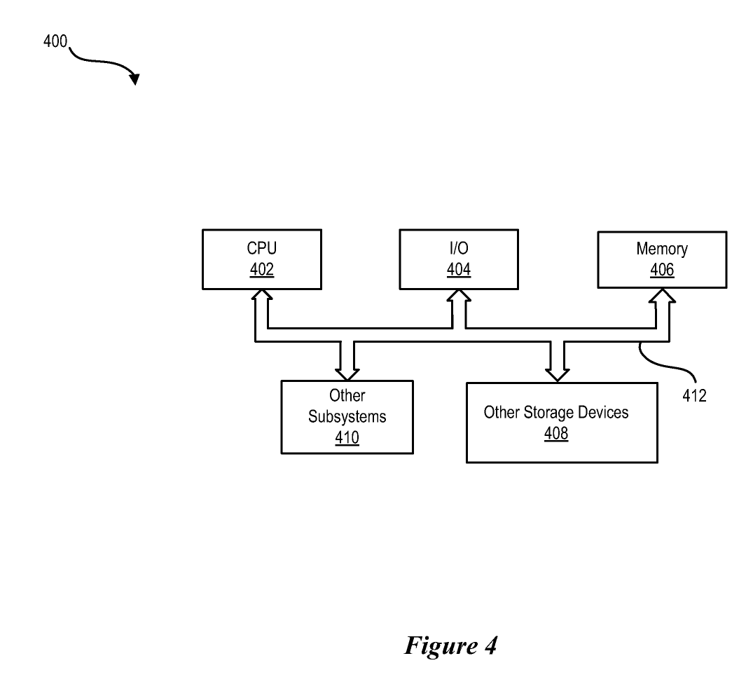

Referring to FIG. 4, a block diagram of an information handling system is shown. The information handling system 400 includes a processor 402, input/output (I/O) devices 404, such as a display, a keyboard, a mouse, and associated controllers (each of which may be coupled to remotely to the information handling system 400), a memory 406 including volatile memory such as random access memory (RAM) and non-volatile memory such as a hard disk and drive, and other storage devices 408, such as an optical disk and drive and other memory devices, and various other subsystems 410, all interconnected via one or more buses 412.

The information handling system 400 may be an information handling system configured via the usage based process for selecting hardware and software in a build to order environment (e.g., the target information handling system 220). Additionally, one or more information handling systems 400 may store and execute the on-line store as well as the various modules within the on-line store. Additionally, the database serer 240 and the file server 242 may each comprise one or more information handling systems 400.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also in certain embodiments, access to the usage based process may be provided via a pop up window that is presented during the configuration process or via a tab that is presented within the configuration page. The information presented via the link, pop up or tab may include an indication such as “Help me Order” as well “Verify system Configuration meets needs”.

Consequently, the invention is intended to be limited only by the spirit and scope of the appended claims, giving full cognizance to equivalents in all respects.

What is claimed is:

1. A system for enabling configuration of an information handling system comprising:
a configurator, the configurator configuring a system with options selected according to user input;
a survey module, the survey module enabling obtaining information from a user and identifying a preferred configuration based upon the information from the user;
an automatic population module, the automatic population module automatically populating an information handling system configuration based upon the preferred configuration;
a database, the database receiving information from and supplying information to the configurator, the survey module and the automatic population module.

2. The system of claim 1 wherein:
the automatically populating the information handling system configuration further comprises performing a configuration accuracy analysis on the information handling system configuration to assure that the information handling system configuration provides a completed and accurately configured information handling system.

3. The system of claim 1 wherein
the survey module presents a plurality of questions to the user.

4. The system of claim 3 wherein
the plurality of questions are presented to the customer via a questionnaire.

5. The system of claim 3 wherein
the plurality of questions comprise at least one of questions regarding a user environment of system, questions regarding potential usage of system, questions regarding types of applications to be used or documents that will be manipulated by the system, questions regarding the ecosystem in which the system will reside and questions regarding whether the system will be coupled to a network and if so the type of network.

6. The system of claim 1 wherein:
the configurator and survey module are presented to the user via a user interface; and,
the survey module is accessed by the user via at least one of a link, a pop up window and a tab presented within the user interface.

7. A method of enabling configuration of an information handling system comprising:
configuring a system with options selected according to user input;
enabling obtaining information from a user and identifying a preferred configuration based upon the information from the user;
automatically populating an information handling system configuration based upon the preferred configuration; and,
receiving information from and supplying information to the configurator, the survey module and the automatic population module via a database.

8. The method of claim 7 wherein:
the automatically populating the information handling system configuration further comprises performing a configuration accuracy analysis on the information handling system configuration to assure that the information handling system configuration provides a completed and accurately configured information handling system.

9. The method of claim 7 wherein
the survey module presents a plurality of questions to the user.

10. The method of claim 9 wherein
the plurality of questions are presented to the customer via a questionnaire.

11. The method of claim 9 wherein
the plurality of questions comprise at least one of questions regarding a user environment of system, questions regarding potential usage of system, questions regarding types of applications to be used or documents that will be manipulated by the system, questions regarding the ecosystem in which the system will reside and questions regarding whether the system will be coupled to a network and if so the type of network.

12. The method of claim 7 wherein:
the configuring and surveying module are presented to the user via a user interface; and,
the surveying is accessed by the user via at least one of a link, a pop up window and a tab presented within the user interface.

13. An on-line store for enabling configuration of an information handling system comprising:
means for configuring a system with options selected according to user input;
means for enabling obtaining information from a user and identifying a preferred configuration based upon the information from the user;
means for automatically populating an information handling system configuration based upon the preferred configuration; and,
a database, the database receiving information from and supplying information to the means for configuring, the means for surveying and the means for automatic populating.

14. The on-line store of claim 13 further comprising:
means for performing a configuration accuracy analysis on the information handling system configuration to assure that the information handling system configuration provides a completed and accurately configured information handling system.

15. The on-line store of claim 13 wherein
the survey module presents a plurality of questions to the user.

16. The on-line store of claim 15 wherein
the plurality of questions are presented to the customer via a questionnaire.

17. The on-line store of claim 15 wherein
the plurality of questions comprise at least one of questions regarding a user environment of system, questions regarding potential usage of system, questions regarding types of applications to be used or documents that will be manipulated by the system, questions regarding the ecosystem in which the system will reside and questions regarding whether the system will be coupled to a network and if so the type of network.

18. The on-line store of claim 13 wherein:
the configuring and surveying module are presented to the user via a user interface; and,
the surveying is accessed by the user via at least one of a link, a pop up window and a tab presented within the user interface.
